(19) United States
(12) Patent Application Publication
(10) Pub. No.: US 2010/0323107 A1
(43) Pub. Date: Dec. 23, 2010

(54) Method for preparing and forming a thick coating of PZT using sol-gel process

(76) Inventors: Yong-kyun Lee, Yongin-city (KR); Chang-jung Kim, Yongin-city (KR)

Correspondence Address: HARNESS, DICKEY & PIERCE, P.L.C., P.O. BOX 8910, RESTON, VA, 20195, US

(21) Appl. No.: 12/662,878

(22) Filed: May 10, 2010

Related U.S. Application Data
(63) Continuation of application No. 10/094,606, filed on Mar. 12, 2002, now abandoned.

(30) Foreign Application Priority Data
Mar. 12, 2001 (KR) 2001-12628

(51) Int. Cl. B05D 3/02; B05D 3/12

(52) U.S. Cl. 427/240

(57) ABSTRACT

A method for preparing and forming a thick coating of lead-zirconate-titanate (PZT) on a substrate, includes preparing a first solution by dissolving a lead precursor in a mixed solvent of acid and diol and stirring the resultant, preparing a second solution by dissolving a zirconium precursor and a titanium precursor in a mixed solvent of acid and diol and stirring the same, mixing the first and second solutions to prepare a PZT stock solution, spin-coating the PZT solution on the substrate to form a coated assembly, and heat-treating the coated assembly.

### BACKGROUND OF THE INVENTION

1. Field of the Invention

The present invention relates to the use of a sol-gel process in preparing lead-zirconate-titanate (PZT) coatings. More particularly, the present invention relates to a method for preparing and forming a dense, thick coating of PZT having excellent electric properties without cracks using a sol-gel process.

2. Description of the Related Art

A sol-gel process used in preparing ceramics generally involves dehydrating a hydrous oxide sol to form a gel, coating a substrate with the gel and thereafter heating the gel to form an inorganic oxide coating on the substrate. Such a sol-gel process is widely applied to preparation of compositions, fine structures, fibers, thick films and so on.

Lead-Zirconate-Titanate (PZT: PbZrₓTi₁₋ₓO₃, where 0≦x≦1) thick coatings have wide applications as piezoelectric materials. Since problems associated with using bulk PZT has been traditionally solved by forming and using multiple thin films, with the ever growing demand for PZT thick coatings, there is an increasing demand for more efficient ways of preparing PZT thick coatings.

A PZT thick coating preparation method in which a PZT thick coating having a thickness of 10 μm or less is formed just by increasing the viscosity of a diol solvent, is disclosed in detail by Y. L. Tu and S. J. Milane in, “Process and characterization of Pb(Zr, Ti)O₃ films, up to 10 μm thick, produced from a diol route,” United Kingdom 1996 MRS.

FIG. 1 shows X-ray diffraction results for a PZT thick coating prepared by a method proposed by Tu and Milane in the above-noted paper, and FIGS. 2A and 2B are photographs of a surface and a cross-section of the PZT thick coating, respectively, taken by a field emission type scanning electron microscope (FE-SEM).
In FIG. 1, the bottom graph (a) shows a PZT thick coating obtained after being preliminarily sintered by a direct insertion method at approximately 600° C. for 20 seconds, and the top graph (b) shows a PZT thick coating obtained after being finally sintered at approximately 700° C. for 15 seconds, where P denotes a pyrochlore phase.

Referring to FIG. 1, the conventional PZT thick coating has a random orientation. Given that a conventional PZT thick coating is randomly grown in a rosette pattern, as shown in FIG. 2A, and that disconnected layer materials are irregularly stacked, as seen from the cross-section thereof in FIG. 2B, it is apparent that conventional PZT thick coatings are difficult to crystallize and grow on platinum (Pt) thick films. When crystallization and growth of the PZT thick coating are successful, an undercoating of a SiO₂ layer having a thickness of 500 nm or greater is required. In consideration of various factors including cost, technical difficulty, processing time and equipment, there is a need to form thinner buffer layers or undercoatings.

### SUMMARY OF THE INVENTION

A feature of an embodiment of the present invention is to provide a method for preparing a PZT thick coating having a dense surface with excellent stability and crystallinity to form a thick film having a thickness of approximately 500 nm at a time that is free of cracks. The PZT thick coating of the present invention requires only a thin undercoating having a preferred thickness of between about 200 nm to about 400 nm, and a more preferred thickness of about 200 nm.

In accordance with a preferred embodiment of the present invention, there is provided a method for preparing and forming a thick coating of Lead-Zirconate-Titanate (PZT) on a substrate, comprising preparing a first solution by dissolving a lead precursor in a mixed solvent of acid and diol; preparing a second solution by dissolving a zirconium precursor and a titanium precursor in a mixed solvent of acid and diol; mixing the first and second solutions to prepare a PZT stock solution; spin-coating the PZT stock solution on the substrate to form a coated assembly; and heat-treating the coated assembly. In preparing the first and second solutions, after dissolving the respective precursors in the mixed solvent of acid and diol, the solutions may be stirred to form uniformly mixed solutions. Also, after mixing the first and second solutions, the PZT stock solution may be prepared by hydrolyzing the mixed solution.

In preparing the second solution, the titanium precursor may be first dissolved in a solution of acid before being mixed with the zirconium precursor and diol. Alternatively, the titanium precursor and the zirconium precursor may be simultaneously dissolved and mixed in a solution of acid and diol.

Further, in preparing the second solution, the titanium precursor and zirconium precursor may be independently dissolved and mixed with a mixed solution of acid and diol before being mixed together.

According to another embodiment of the present invention, a distillation process is included in preparing the first, second and PZT stock solutions. For example, the first solution and the second solution as well as the PZT stock may each be distilled before use.

The heat-treating of the coated assembly may include baking the coated assembly in air at a temperature of about 350 to 400° C., pre-annealing the baked coated assembly in air at a temperature of about 550 to 650° C., and finally annealing the pre-annealed coated assembly in air at a temperature of about 650 to 700° C.

Preferably, the baking and pre-annealing are repeated one or more times.

The lead precursor may be one selected from the group consisting of lead oxide (PbOₓ, lead acetate trihydride and lead 2-ethyl hexanoate.

The titanium precursor is preferably one selected from the group consisting of Ti(i-OPr)₄ and Ti(i-OBt)₄, where i-OPr and i-OBt represent an isopropyl group and an isobutyl group, respectively.

The zirconium precursor may be one selected from the group consisting of Zr(n-OPr)₄ and Zr(n-OBt)₄, where i-OPr and i-OBt represent a 1-propyl group and a 1-butyl group, respectively.

The acid solvent is preferably one selected from the group consisting of acetic acid and a diol-series solvent.

The diol solvent is preferably one selected from the group consisting of 1,3-propanediol, 1,3-butanediol, 1,4-butanediol, 1,2-propanediol and ethylene glycol.

Preferably, in the case where the diol solvent is ethylene glycol, lead 2-ethyl hexanoate, Zr(n-OBt)₄ and 2-ethyl hexanoate are used as a lead precursor, a zirconium precursor and an acid solvent, respectively.

Preferably, the PZT stock solution has a concentration in the range of about 0.1 to about 2 M.

Also, the respective precursor solutions may be prepared in an inert gas atmosphere at room temperature, 25° C. to 350° C.

The respective precursors may be based on ligand substitution with 1,3-propoxide.

### BRIEF DESCRIPTION OF THE DRAWINGS

The above-mentioned features and advantages of the present invention will become more apparent by describing in detail preferred embodiments thereof with reference to the attached drawings in which:

FIG. 1 is a graph illustrating X-ray diffraction results for a conventional PZT thick coating;

FIG. 2A is a photograph of a surface of the conventional PZT thick coating taken by a field emission type scanning electron microscope (FE-SEM);

FIG. 2B is a photograph of a cross-section of the conventional PZT thick coating taken by a field emission type scanning electron microscope (FE-SEM);

FIGS. 3A and 3B are graphs illustrating X-ray diffraction results for a PZT thick coating prepared in accordance with Example 6 of the present invention;

FIG. 4A is a photograph of a surface of the PZT thick coating prepared in accordance with Example 6 of the present invention, taken by a field emission type scanning electron microscope (FE-SEM);

FIG. 4B is a photograph of a cross-section of the PZT thick coating prepared in accordance with Example 6 of the present invention, taken by a field emission type scanning electron microscope (FE-SEM); and

FIG. 5 is a graph illustrating test results of electric properties of the PZT thick coating prepared in accordance with Example 6 of the present invention.

### DETAILED DESCRIPTION OF THE INVENTION

Korean Patent Application No. 2001-12628, filed on Mar. 12, 2001, and entitled: “Method for Preparing a Thick Coating of PZT Using Sol-Gel Process,” is hereby incorporated by reference in its entirety.

The present invention will now be described in more detail with reference to the accompanying drawings.

The present invention is directed to a method for preparing a thick coating of PZT exhibiting excellent electric properties with excellent stability and crystallinity using a standard sol-gel process and metal-ligand substitution.

A feature of an embodiment of the present invention is based on the discovery that under certain atmospheric conditions, a thicker coating on a substrate may be formed in a solution by stabilizing metal ligands. Moreover, the problems associated with conventional PZT thick coatings, that is, cracks or restricted thickness conditions, may be overcome by use of a solution system in accordance with the present invention. For example, whereas a conventional solution system used for a platinum (Pt) electrode requires a SiO₂ undercoating layer having a thickness of at least 500 nm, the solution system according to the present invention allows a PZT thick coating to be grown using only a 200 nm thick SiO₂ undercoating layer while maintaining excellent stability and crystallinity.

In accordance with a preferred embodiment of the present invention, a PZT stock solution is prepared in an inert gas atmosphere, e.g., a nitrogen or argon atmosphere. Distillation is optional and may be performed in the course of preparing the solution or at the final stage of the process or it may not be performed at all. If distillation is performed, it is for the purpose of removing alcohol produced from a diol solvent, other metal ligands as well as acetic acid which is added as a stabilizer.

Unlike the conventional method, the method according to the present invention employs a single precursor instead of various precursors for metal ligands, thereby allowing phase formation at a stable, low temperature. Therefore, the method according to the present invention may be advantageously employed in a low-temperature process, e.g., approximately 550° C. This feature of the present invention is derived from a solvent-like ligand of precursors for the various metal ligands, and uniform, stable sol-gel chains contained therein. Accordingly, the solution system of the present invention has increased stability and durability compared to the conventional solution system. Also, the thick coating has much improved fineness at its surface with good wettability and reveals no striped pattern.

In particular, according to the present invention, cracking, which is the most serious problem in the manufacture of thick coatings of PZT, may be prevented and avoided.

A method for preparing a thick coating of PZT will now be described in more detail with reference to the following examples.

### Example 1

Lead acetate trihydrate, zirconium n-propoxide and titanium iso-propoxide were prepared as a lead precursor, a zirconium precursor and a titanium precursor, respectively.

First, 23.44 g of lead acetate trihydrate was added to 5 ml of acetic acid and 20 ml of 1,3-propanediol in a nitrogen atmosphere and heated at 150° C. for 4 hours while stirring to distill metal ligand based alcohol other than diol and acetic acid which was added as a stabilizer.

For stabilization, 12.57 g of zirconium n-propoxide and 9.05 g of titanium iso-propoxide were added to 10 ml of acetic acid and mixed. To the resultant solution, 20 ml of 1,3-propanediol was added and heated at 150° C. or higher for 4 hours while stirring, to distill metal ligand based alcohol other than diol and acetic acid which was added as a stabilizer.

To acquire a 1M PZT stock solution, 20 ml of the prepared lead precursor solution and 40 ml of zirconium-titanium precursor solution were mixed and heated at 150° C. or higher for 4 hours while stirring, to distill metal ligand based alcohol other than diol and acetic acid which was added as a stabilizer, followed by hydrolysis and filtration.

### Example 2

Lead oxide (PbOₓ), zirconium n-propoxide and titanium iso-propoxide were prepared as a lead precursor, a zirconium precursor and a titanium precursor, respectively.

First, 11.15 g of lead oxide was added to 5 ml of acetic acid and 10 ml of 1,3-propanediol in a nitrogen atmosphere and heated at 150° C. for 4 hours while stirring to distill metal ligand based alcohol other than diol and acetic acid which was added as a stabilizer.

For stabilization, 12.57 g of zirconium n-propoxide and 9.05 g of titanium iso-propoxide were added to 10 ml of acetic acid and mixed. To the resultant solution, 20 ml of 1,3-propanediol was added and heated at 150° C. or higher for 4 hours while stirring, to distill metal ligand based alcohol other than diol and acetic acid which was added as a stabilizer.

To acquire a 1M PZT stock solution, 15 ml of the prepared lead precursor solution and 40 ml of the zirconium-titanium precursor solution were mixed and heated at 150° C. or higher for 4 hours while stirring, to distill metal ligand based alcohol other than diol and acetic acid which was added as a stabilizer, followed by hydrolysis and filtration.

### Example 3

Lead oxide (PbOₓ), zirconium n-propoxide and titanium iso-propoxide were prepared as a lead precursor, a zirconium precursor and a titanium precursor, respectively.

First, 11.15 g of lead oxide was added to 5 ml of acetic acid and 10 ml of 1,3-propanediol in a nitrogen atmosphere and heated at 150° C. for 4 hours while stirring, to distill metal ligand based alcohol other than diol and acetic acid which as added as a stabilizer.

Then, 12.57 g of zirconium n-propoxide was added to a mixed solution of 5 ml of acetic acid and 15 ml of 1,3-propanediol and distilled while stirring.

9.05 g of titanium iso-propoxide was added to a mixed solution of 5 ml of acetic acid and 15 ml of 1,3-propanediol and distilled while stirring.

To acquire a 1M PZT stock solution, 15 ml of the prepared lead precursor solution, 20 ml of the zirconium precursor solution and 20 ml of the titanium precursor solution were mixed and heated at 150° C. or higher for 4 hours while stirring, followed by hydrolysis and filtration.

### Example 4

A 1M PZT stock solution was acquired in the same manner as in Example 1, except hydrolysis was not performed.

### Example 5

A 1M PZT stock solution was acquired in the same manner as in Example 1, except distillation was not performed.

A method for preparing a PZT thick film using the PZT stock solutions prepared in Example 1 and 5 will now be described.

### Example 6

The 1M PZT stock solution prepared in Example 1 was spin-coated on a substrate made of Pt (270 nm)/Ti (30 nm)/SiO₂ (200 nm)/Si to a thickness of 250 nm. The resultant coated substrate was baked in air at a temperature of about 350° C. to 400° C. and pre-annealed in oxygen at a temperature of about 550° C. to 650° C. by a rapid thermal process (RTP). This procedure was repeated several times, thereby obtaining a 3 μm thick coating of PZT. The obtained PZT thick coating was finally annealed by RTP in oxygen at a temperature of about 650° C. to 700° C.

### Example 7

A thick coating of PZT was obtained in the same manner as in Example 6, except a PTO (PbTiO₃) seed layer was coated once at an initial stage.

Then, the resultant seed layer coated substrate was pre-baked at a temperature of about 150° C. to 300° C., baked at a temperature of about 350° C. to 400° C. and then pre-annealed in oxygen at a temperature of about 550° C. to 650° C. by RTP. This procedure was repeated 10 times, thereby obtaining a 3.2 μm thick coating of PZT. The obtained PZT thick coating was finally annealed by RTP in oxygen at a temperature of about 650° C. to 700° C.

### Example 8

A thick coating of PZT was obtained in the same manner as in Example 6, except pre-annealing was performed in a N₂ furnace.

### Example 9

A thick coating of PZT was obtained in the same manner as in Example 6, except pre-annealing was performed in oxygen using a hot plate.

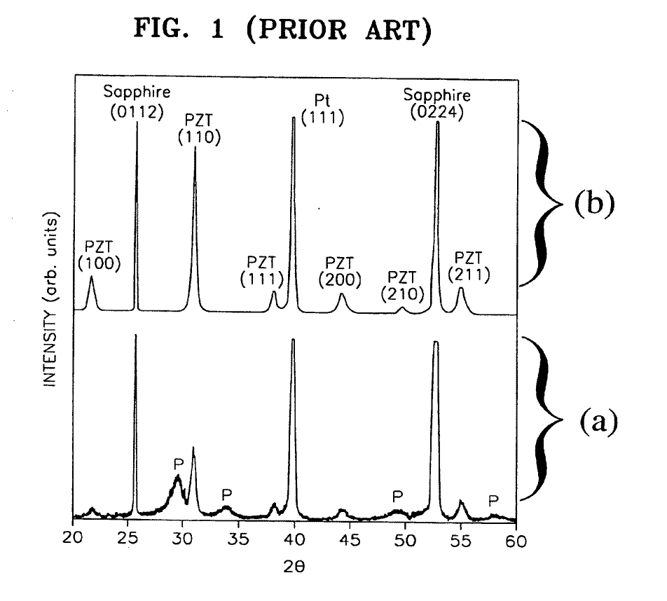

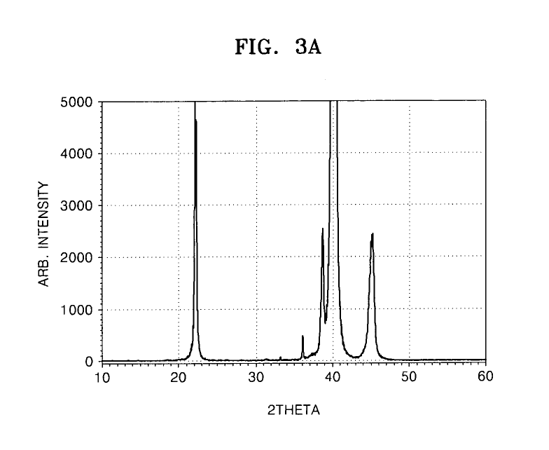

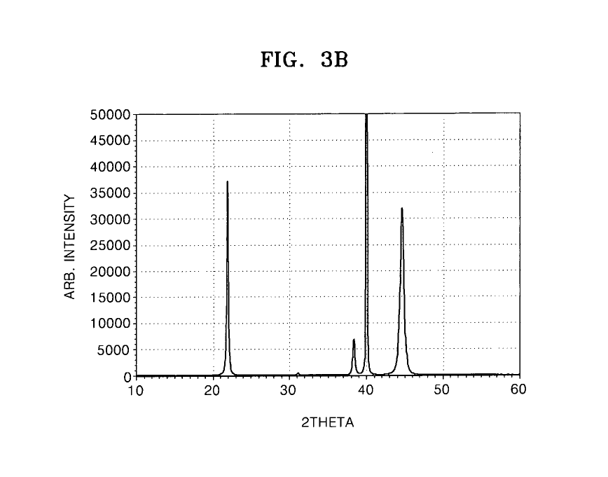

FIGS. 3A and 3B are graphs illustrating X-ray diffraction results for a PZT thick coating prepared in accordance with Example 6 of the present invention, after being primarily annealed and finally annealed, respectively. Whereas the thick coating shown in FIG. 1 is grown in a direction in which crystal orientation is random with the (110) peak being formed around 31 degrees, the thick coatings shown in FIGS. 3A and 3B are grown in one direction, i.e., in the (100) orientation. In other words, the known conventional thick coating disclosed in the above-referenced article tends to grow randomly, whereas the thick coating according to the present invention grows dominantly in the (100) orientation. Thus, the PZT thick coating prepared according to the present invention is advantageous in view of electrical characteristics such as retention.

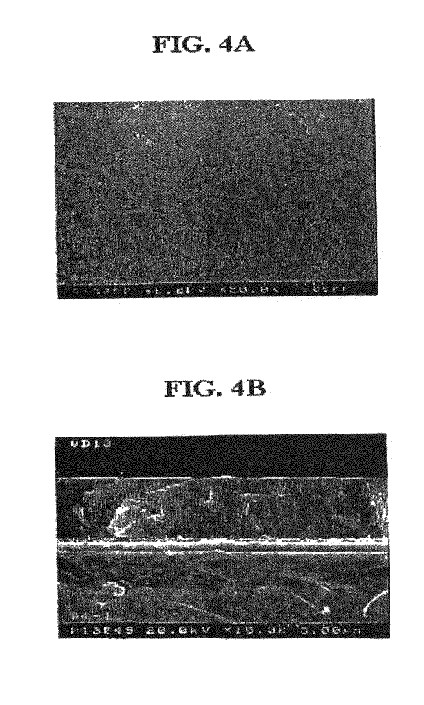

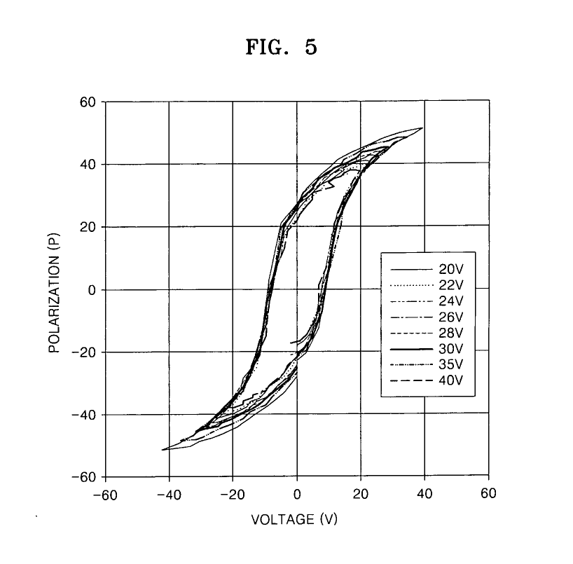

FIGS. 4A and 4B are photographs of a surface and a cross-section, respectively, of the PZT thick coating prepared in Example 6 of the present invention, taken by a field emission type scanning electron microscope (FE-SEM).

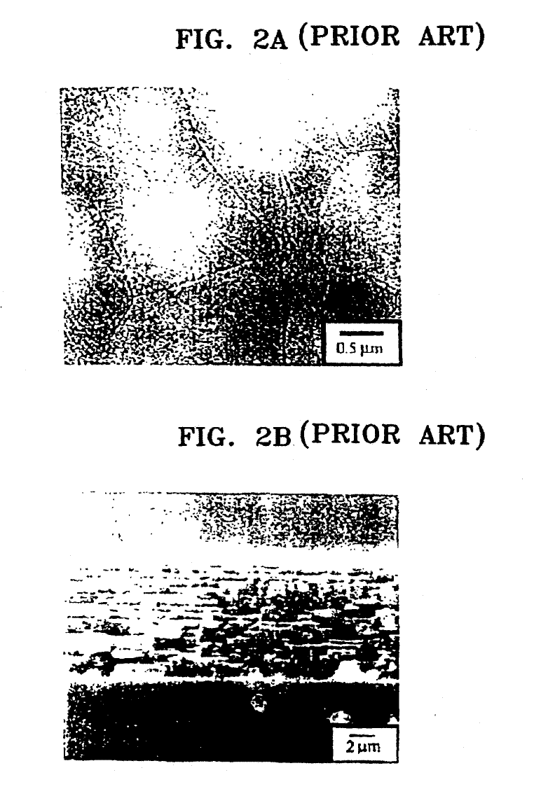

Referring back to FIGS. 2A and 2B showing the surface and cross-section of the conventional PZT thick coating, the conventional PZT thick coating is randomly grown in a rosette pattern and disconnected layer materials are irregularly stacked. Referring to FIGS. 4A and 4B, however, the PZT thick coating according to the present invention has a surface of small, densely populated grains.

FIG. 5 shows the test results of electric properties of the PZT thick coating prepared in Example 6 of the present invention. As may be seen in FIG. 5, the PZT thick coating is almost saturated at 20 V and shows a high remnant polarization value even with a composition ratio of 52/48 (Zr:Ti).

The PZT thick coating prepared according to the present invention also has the following additional characteristics. Since the PZT thick coating exhibits good crystallinity at 550° C., it may be advantageously used in a low-temperature process. Also, according to the present invention, little cracks are generated during heat treatment. Unlike in the prior art, in which it is difficult to crystallize and grow, conventional PZT thick coatings on platinum (Pt) thick films, and in which if crystallization and growth are successful, there must be a SiO₂ layer as an undercoating having a thickness that is 500 nm or greater, the thick coating of PZT according to the present invention may be formed using only a 200 nm thick SiO₂ layer as a undercoating while exhibiting excellent stability and crystallinity.

According to the present invention, a dense, thick coating of PZT without cracks and having excellent stability, crystallinity and other electric properties, may be prepared using a sol-gel process by stabilizing the respective metal ligands.

Preferred embodiments of the present invention have been disclosed herein, and although specific terms are employed, they are used in a generic and descriptive sense only and not for purpose of limitation. Accordingly, it will be understood by those of ordinary skill in the art that various changes in form and details may be made without departing from the spirit and scope of the invention as set forth in the following claims.

What is claimed is:

1. A method for preparing and forming a thick coating of lead-zirconate-titanate (PZT) on a substrate, comprising:
preparing a first solution by dissolving a lead precursor in a mixed solvent of acid and diol;
preparing a second solution by dissolving a zirconium precursor and a titanium precursor in a mixed solvent of acid and diol;
mixing the first and second solutions to prepare a PZT stock solution;
spin-coating the PZT stock solution on the substrate to form a coated assembly; and
heat-treating the coated assembly.

2. A method for preparing and forming a thick coating of lead-zirconate-titanate (PZT) on a substrate as claimed in claim 1, wherein after dissolving the lead precursor in the mixed solvent of acid and diol, the first solution is prepared by stirring.

3. A method for preparing and forming a thick coating of lead-zirconate-titanate (PZT) on a substrate as claimed in claim 1, wherein after the zirconium precursor and the titanium precursor are dissolved in the mixed solvent of acid and diol, the second solution is prepared by stirring.
